(19) United States
(12) Patent Application Publication
(10) Pub. No.: US 2012/0001932 A1
(43) Pub. Date: Jan. 5, 2012

(54) SYSTEMS AND METHODS FOR ASSISTING VISUALLY-IMPAIRED USERS TO VIEW VISUAL CONTENT

(76) Inventors: William R. Burnett, Menlo Park, CA (US); Howard Kaplan, Armonk, NY (US); Janet Shimer, Armonk, NY (US); Cynthia Benjamin, Menlo Park, CA (US)

(21) Appl. No.: 13/172,779

(22) Filed: Jun. 29, 2011

Related U.S. Application Data
(60) Provisional application No. 61/361,246, filed on Jul. 2, 2010.

(51) Int. Cl. G09G 5/00; G09G 5/02

(52) U.S. Cl. 345/589; 345/581

(57) ABSTRACT

Methods, systems and computer program products for assisting a visually-impaired user to view visual content.

### CROSS-REFERENCE

This application claims priority to provisional U.S. Patent Application No. 61/361,246, filed Jul. 2, 2010, entitled “SYSTEMS AND METHODS FOR ASSISTING VISUALLY-IMPAIRED USERS TO VIEW VISUAL CONTENT,” the aforementioned application being hereby incorporated by reference in its entirety.

### FIELD OF THE INVENTION

Embodiments generally relate to systems and methods for assisting visually-impaired users to view visual content using one or more data processing systems.

### SUMMARY OF THE INVENTION

In various example embodiments, systems, methods, and computer program products for assisting a visually-impaired user to view visual content are provided.

### INCORPORATION BY REFERENCE

All publications, patents, and patent applications mentioned in this specification, if any, are herein incorporated by reference to the same extent as if each individual publication, patent, or patent application was specifically and individually indicated to be incorporated by reference.

### BRIEF DESCRIPTION OF THE DRAWINGS

The accompanying figures, which together with the detailed description below are incorporated in and form part of the specification, serve to further illustrate various embodiments and to explain various principles and advantages all in accordance with example embodiments.

FIG. 1 shows an example of a data processing system within which a set of instructions may be executed in connection with various embodiments.

FIG. 2 shows an exemplary data processing system that may be configured to execute instructions for performing functions and processes in connection with various embodiments.

FIG. 3 shows an exemplary data processing system configured to assist a visually-impaired user to view visual content, in accordance with an embodiment.

FIG. 4 shows a flowchart illustrating a method and process for the operation of an exemplary data processing system configured to assist a visually-impaired user to view visual content, in accordance with an embodiment.

FIG. 5 shows an exemplary data processing system configured to assist a visually-impaired user to view visual content, in accordance with an embodiment.

FIG. 6 illustrates the architecture and functionality of an exemplary embodiment of a logic module that processes visual content to produce modified visual content, in accordance with an embodiment.

FIG. 7 shows an exemplary data processing system configured to assist a visually-impaired user that is affected by a peripheral retinal function impairment condition to view visual content, in accordance with an embodiment.

FIG. 8 shows a flowchart illustrating a method and process for the operation of an exemplary data processing system configured to assist a visually-impaired user that is affected by a peripheral retinal function impairment condition to view visual content, in accordance with an embodiment.

FIG. 9 shows an exemplary data processing system configured to assist a visually-impaired user affected by a peripheral retinal function impairment condition to view visual content, in accordance with an embodiment.

FIG. 10 shows an exemplary data processing system configured to assist a visually-impaired user that is affected by a macular impairment condition to view visual content, in accordance with an embodiment.

FIG. 11 shows a flowchart illustrating a method and process for the operation of an exemplary data processing system configured to assist a visually-impaired user that is affected by a macular impairment condition to view visual content, in accordance with an embodiment.

FIG. 12 shows an exemplary data processing system configured to assist a visually-impaired user affected by a macular impairment condition to view visual content, in accordance with an embodiment.

### DETAILED DESCRIPTION

While the specification concludes with claims defining the features of the invention that are regarded as novel, the invention will be better understood from a consideration of the following description in conjunction with the drawing figures, in which like reference numerals are carried forward.

A data processing system, as applicable to various embodiments, includes any desktop computer, laptop, netbook, electronic notebook, ultra mobile personal computer (UMPC), client computing device, server computer or server system (whether configured as a single server or as a bank of multiple servers), cloud computing system or platform, web appliance, network router, switch or bridge, mobile telephone, personal digital assistant, personal digital organizer, or any other computer system, device, component or machine capable of processing electronic data. In various implementations, a data processing system could act as a client, as a server, or as both a client and a server.

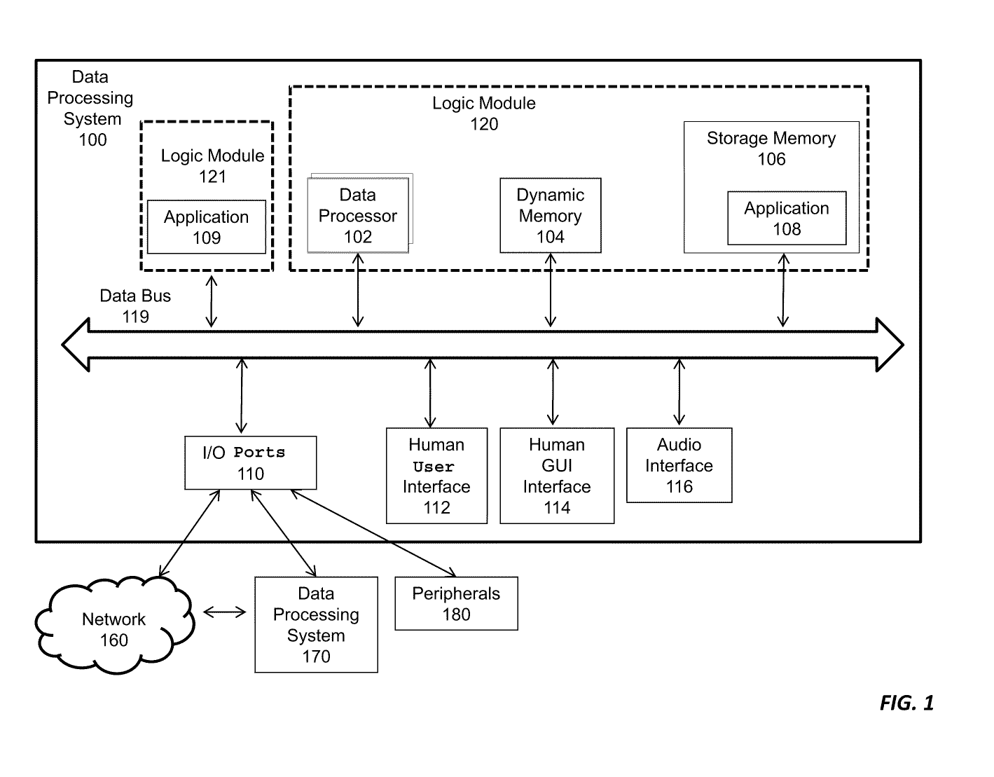

FIG. 1 shows a representation of an example of a data processing system 100 that may be used in connection with various embodiments and which may be configured to execute instructions for performing functions and methods. The exemplary data processing system 100 includes a data processor 102.

Data processor 102 represents one or more general-purpose data processing devices such as a microprocessor or other central processing unit. More particularly, the processing device may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets, whether in a single core or in a multiple core architecture. Data processor 102 may also be or include one or more special-purpose processing devices such as an application specific integrated circuit (ASIC), a field programmable gate array (FPGA), a digital signal processor (DSP), network processor, any other embedded processor, or the like. The data processor 102 may execute instructions for performing operations and steps in connection with various embodiments.

In this exemplary embodiment, the data processing system 100 further includes a dynamic memory 104, which may be designed to provide higher data read speeds. Examples of dynamic memory 104 include dynamic random access memory (DRAM), synchronous DRAM (SDRAM) memory, read-only memory (ROM) and flash memory. The dynamic memory 104 may be adapted to store all or part of the instructions of a software application, as these instructions are being executed or may be scheduled for execution by data processor 102. In some implementations, the dynamic memory 104 may include one or more cache memory systems that are designed to facilitate lower latency data access by the data processor 102.

In general, unless otherwise stated or required by the context, when used in connection with a method, data processing system or logic module, the words “adapted” and “configured” are intended to describe that the respective method, data processing system or logic module is capable of performing the respective functions by being appropriately adapted or configured (e.g., via programming, via the addition of relevant components or interfaces, etc.), but are not intended to suggest that the respective method, data processing system or logic module is not capable of performing other functions. For example, unless otherwise expressly stated, a logic module that is described as being adapted to process a specific class of information will not be construed to be exclusively adapted to process only that specific class of information, but may in fact be able to process other classes of information and to perform additional functions (e.g., receiving, transmitting, converting, or otherwise processing or manipulating information).

In this exemplary embodiment, the data processing system 100 further includes a storage memory 106, which may be designed to store larger amounts of data. Examples of storage memory 106 include a magnetic hard disk and a flash memory module. In various implementations, the data processing system 100 may also include, or may otherwise be configured to access one or more external storage memories, such as an external memory database or other memory data bank, which may either be accessible via a local connection (e.g., a USB or WiFi interface), or via a network (e.g., a remote cloud-based memory volume).

A storage memory may also be a memory medium, storage medium, dynamic memory, or memory, etc. In general, a storage memory, such as the dynamic memory 104 and the storage memory 106, may include any chip, device, combination of chips and/or devices, or other structure capable of storing electronic information, whether temporarily, permanently or quasi-permanently. A memory medium could be based on any magnetic, optical, electrical, mechanical, electromechanical, MEMS, quantum, or chemical technology, or any other technology or combination of the foregoing that is capable of storing electronic information. A memory medium could be centralized, distributed, local, remote, portable, or any combination of the foregoing. Examples of memory media include a magnetic hard disk, a random access memory (RAM) module, an optical disk (e.g., DVD, CD), and a flash memory card, stick, disk or module.

A software application or module, and any other computer executable instructions, may be stored on any such storage memory, whether permanently or temporarily, including on any type of disk (e.g., a floppy disk, optical disk, CD-ROM, and other magnetic-optical disks), read-only memory (ROM), random access memory (RAM), EPROM, EEPROM, magnetic or optical card, or any other type of media suitable for storing electronic instructions.

In general, a storage memory could host a database, or a part of a database. Conversely, in general, a database could be stored completely on a particular storage memory, could be distributed across a plurality of storage memories, or could be stored on one particular storage memory and backed up or otherwise replicated over a set of other storage memories. Examples of databases include operational databases, analytical databases, data warehouses, distributed databases, end-user databases, external databases, hypermedia databases, navigational databases, in-memory databases, document-oriented databases, real-time databases and relational databases.

Storage memory 106 may include one or more software applications 108, in whole or in part, stored thereon. In general, a software application, also denoted a data processing application or an application, may include any software application, software module, function, procedure, method, class, process, or any other set of software instructions, whether implemented in programming code, firmware, or any combination of the foregoing. A software application may be in source code, assembly code, object code, or any other format. In various implementations, an application may run on more than one data processing system (e.g., using a distributed data processing model or operating in a computing cloud), or may run on a particular data processing system or logic module and may output data through one or more other data processing systems or logic modules.

The exemplary data processing system 100 may include one or more logic modules 120 and/or 121, also denoted data processing modules, or modules. Each logic module 120 and/or 121 may consist of (a) any software application, (b) any portion of any software application, where such portion can process data, (c) any data processing system, (d) any component or portion of any data processing system, where such component or portion can process data, and (e) any combination of the foregoing. In general, a logic module may be configured to perform instructions and to carry out the functionality of one or more embodiments of the present invention, whether alone or in combination with other data processing modules or with other devices or applications. Logic modules 120 and 121 are shown with dotted lines in FIG. 1 to further emphasize that data processing system 100 may include one or more logic modules, but does not have to necessarily include more than one logic module.

As an example of a logic module comprising software, logic module 121 shown in FIG. 1 consists of application 109, which may consist of one or more software programs and/or software modules. Logic module 121 may perform one or more functions if loaded on a data processing system or on a logic module that comprises a data processor.

As an example of a logic module comprising hardware, the data processor 102, dynamic memory 104 and storage memory 106 may be included in a logic module, shown in FIG. 1 as exemplary logic module 120. Examples of data processing systems that may incorporate both logic modules comprising software and logic modules comprising hardware include a desktop computer, a mobile computer, or a server computer, each being capable of running software to perform one or more functions defined in the respective software.

In general, functionality of logic modules may be consolidated in fewer logic modules (e.g., in a single logic module), or may be distributed among a larger set of logic modules. For example, separate logic modules performing a specific set of functions may be equivalent with fewer or a single logic module performing the same set of functions. Conversely, a single logic module performing a set of functions may be equivalent with a plurality of logic modules that together perform the same set of functions. In the data processing system 100 shown in FIG. 1, logic module 120 and logic module 121 may be independent modules and may perform specific functions independent of each other. In an alternative embodiment, logic module 120 and logic module 121 may be combined in whole or in part in a single module that perform their combined functionality. In an alternative embodiment, the functionality of logic module 120 and logic module 121 may be distributed among any number of logic modules. One way to distribute functionality of one or more original logic modules among different substitute logic modules is to reconfigure the software and/or hardware components of the original logic modules. Another way to distribute functionality of one or more original logic modules among different substitute logic modules is to reconfigure software executing on the original logic modules so that it executes in a different configuration on the substitute logic modules while still achieving substantially the same functionality. Examples of logic modules that incorporate the functionality of multiple logic modules and therefore can be construed themselves as logic modules include system-on-a-chip (SoC) devices and a package on package (PoP) devices, where the integration of logic modules may be achieved in a planar direction (e.g., a processor and a storage memory disposed in the same general layer of a packaged device) and/or in a vertical direction (e.g. using two or more stacked layers).

The exemplary data processing system 100 may further include one or more input/output (I/O) ports 110 for communicating with other data processing systems 170, with other peripherals 180, or with one or more networks 160. Each I/O port 110 may be configured to operate using one or more communication protocols. In general, each I/O port 110 may be able to communicate through one or more communication channels. The data processing system 100 may communicate directly with other data processing systems 170 (e.g., via a direct wireless or wired connection), or via the one or more networks 160.

A communication channel may include any direct or indirect data connection path, including any wireless connection (e.g., Bluetooth, WiFI, WiMAX, cellular, 3G, 4G, EDGE, CDMA and DECT), any wired connection (including via any serial, parallel, wired packet-based communication protocol (e.g., Ethernet, USB, FireWire, etc.), or other wireline connection), any optical channel, and any other point-to-point connection capable of transmitting data.

Each of the networks 160 may include one or more communication channels. In general, a network, or data network, consists of one or more communication channels. Examples of networks include LANs, MANs, WANs, cellular and mobile telephony networks, the Internet, the World Wide Web, and any other information transmission network. In various implementations, the data processing system 100 may include interfaces and communication ports in addition to the I/O ports 110.

The exemplary data processing system 100 may further include a human user interface 112, which provides the ability for a user to visualize data output by the data processing system 100. The human user interface 112 may directly or indirectly provide a graphical user interface (GUI) adapted to facilitate presentation of data to a user. The human user interface 112 may consist of a set of visual displays (e.g., an integrated LCD, LED or CRT display), of a set of interfaces and/or connectors to one or more external visual displays (e.g., an LCD display or an optical projection device), or of a combination of the foregoing.

A visual display may also be denoted a graphic display, computer display, display, computer screen, screen, computer panel, or panel. Examples of displays include a computer monitor, an integrated computer display, electronic paper, a flexible display, a touch panel, a transparent display, and a three dimensional (3D) display that may or may not require a user to wear assistive 3D glasses.

A data processing system may incorporate a graphic display. Examples of such data processing systems include a laptop, a computer pad or notepad, a tablet computer, an electronic reader (also denoted an e-reader or ereader), a smart phone, a personal data assistant (PDA). The graphic displays incorporated in such data processing systems may include active display, passive displays, LCD displays, LED displays, OLED displays, plasma displays, and any other type of visual display that is capable of displaying electronic information to a user. Such graphic displays may permit direct interaction with a user, either through direct touch by the user (e.g. sensing a user's finger touching a particular area of the display), through proximity interaction with a user (e.g., sensing a user's finger being in proximity to a particular area of the display), or through a stylus or other input device.

The exemplary data processing system 100 may further include one or more human input interfaces 112, which facilitate data entry by a user or other interaction by a user with the data processing system 100. Examples of the human user interface 112 include a keyboard, a mouse (whether wired or wireless), a stylus, other wired or wireless pointer devices (e.g., a remote control), or any other user device capable of interfacing with the data processing system 100. In some implementations, the human user interface 112 may include one or more sensors that provide the ability for a user to interface with the data processing system 100 via voice, or provide user intention recognition technology (including optical, facial, or gesture recognition), or gesture recognition (e.g., recognizing a set of gestures based on movement via motion sensors such as gyroscopes, accelerometers, magnetic sensors, optical sensors, etc.).

The exemplary data processing system 100 may further include one or more gyroscopes, accelerometers, magnetic sensors, optical sensors, or other sensors that are capable of detecting physical movement of the data processing system. Such movement may include larger amplitude movements (e.g., a device being lifted by a user off a table and carried away), smaller amplitude movements (e.g., a device being brought closer to the face of a user or otherwise being moved in front of a user while the user is viewing content on the display), or higher frequency movements (e.g., user hand tremor).

The exemplary data processing system 100 may further include an audio interface 116, which provides the ability for the data processing system 100 to output sound (e.g., a speaker), to input sound (e.g., a microphone), or any combination of the foregoing.

The exemplary data processing system 100 may further include any other components that may be advantageously used in connection with receiving, processing and/or transmitting information.

In the exemplary data processing system 100, the data processor 102, dynamic memory 104, storage memory 106, I/O port 110, GUI user interface 114, human input interface 112, audio interface 116, and logic module 121 communicate to each other via the data bus 119. In some implementations, there may be one or more data buses in addition to the data bus 119 that connect some or all of the components of data processing system 100, including possibly dedicated data buses that connect only a subset of such components. Each such data bus may implement open industry protocols (e.g., a PCI or PCI-Express data bus), or may implement proprietary protocols.

Some of the embodiments described in this specification may be presented in terms of algorithms and symbolic representations of operations on data bits within a computer memory. In general, an algorithm represents a sequence of steps leading to a desired result. Such steps generally require physical manipulations of physical quantities. Usually, though not necessarily, these quantities take the form of electrical or magnetic signals capable of being stored, transferred, combined, compared, and otherwise manipulated using appropriate electronic devices. Such signals may be denoted as bits, values, elements, symbols, characters, terms, numbers, or using other similar terminology.

When used in connection with the manipulation of electronic data, terms such as processing, computing, calculating, determining, displaying, or the like, refer to the action and processes of a computer system or other electronic system that manipulates and transforms data represented as physical (electronic) quantities within the system's registers and memories into other data similarly represented as physical quantities within the memories or registers of that system of or other information storage, transmission or display devices.

Various embodiments of the present invention may be implemented using an apparatus or machine that executes programming instructions. Such an apparatus or machine may be specially constructed for the required purposes, or may comprise a general purpose computer selectively activated or reconfigured by a software application.

Algorithms discussed in connection with various embodiments of the present invention are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments are not described with reference to any particular programming language, data transmission protocol, or data storage protocol. Instead, a variety of programming languages, transmission or storage protocols may be used to implement various embodiments.

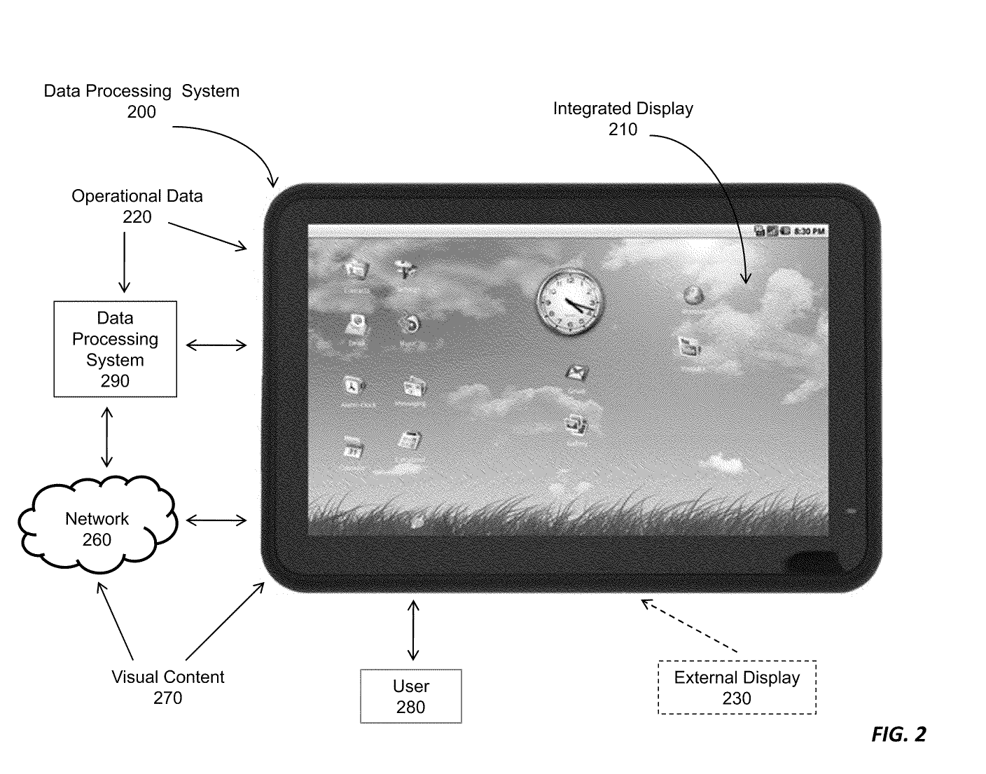

FIG. 2 shows an exemplary data processing system 200 that may be used in connection with various embodiments and which may be configured to execute instructions for performing functions and processes. The data processing system 200 includes an integrated display 210.

In one implementation, the data processing system 200 has the capability to output some or all of the information normally displayed on the integrated display 210 to one or more external displays, illustrated in FIG. 2 as external display 230. The external display 230 could act either as an alternative display (e.g., providing extended desktop functionality) or as a clone display (e.g., displaying the same content as integrated display 210 on a larger television set display or computer monitor). In an alternative embodiment, the data processing system 200 may not include an integrated display at all, or the integrated display 210 may be turned off; in that case, the data processing system 200 could output all visual content to one or more external displays 230. In general, the external display 230 may be optional for the embodiment of FIG. 2, and this is emphasized in FIG. 2 using dotted lines.

In the embodiment of FIG. 2, the data processing system 200 is configured to allow a user 280 to view visual content displayed on the integrated display 210. The integrated display 210 may be a touch sensitive screen and may display a GUI to facilitate interaction of the user 280 with the data processing system 200.

The integrated display 210 may be configured to display visual content 270 to the user 280. In general, visual content may include any text in any language or code, any character, symbol, image, graphic, video, or any other type of static, dynamic or multimedia content that can be represented on a display, in standard two-dimensional representations or in pseudo three-dimensional representations utilizing direct view or stereoscopic glasses technology.

The visual content 270 may be transmitted to the data processing system 200 and/or stored on the data processing system 200 either directly, or through network 260. The data processing system 200 may request the visual content 270 (e.g., using a pull data transfer mode) from an external source or may passively receive the visual content 270 from an external source (e.g., the external source may be using a push data transfer mode). The external source may be one or more data processing systems, illustrated in FIG. 2 as data processing system 290.

The visual content 270 may be received in discrete units (e.g., an electronic book downloaded in one transaction, a web page, or an image), or may be received on a continuous basis (e.g., a stream of text or images).

In general, visual content may be received from any source via a wired or wireless transmission (e.g., a webpage viewed by the user 280 via a wired broadband connection or via a WiFi network), or may be loaded on, installed on, or otherwise made available to the data processing system 200 from a local storage memory (e.g., via a USB flash memory device attached to the data processing system 200).

The data processing system 290 may also receive operational data 220, either directly or through the network 260. In one implementation, the operational data 220 includes parameters for the configuration of the data processing system 200. In one implementation, the operational data 220 includes parameters for the configuration of the one or more applications running on the data processing system 200. In one implementation, the operational data 220 includes an application or a portion of an application to be executed on the data processing system 200. The data processing system 200 may request the operational data 220 (e.g., using a pull data transfer mode) from an external source or may passively receive the operational data 220 from an external source (e.g., the external source may be using a push data transfer mode). The external source may be one or more data processing systems, including data processing system 290.

### A. General Visual Deficiency Exemplary Embodiment

1. Architecture and Process Flow

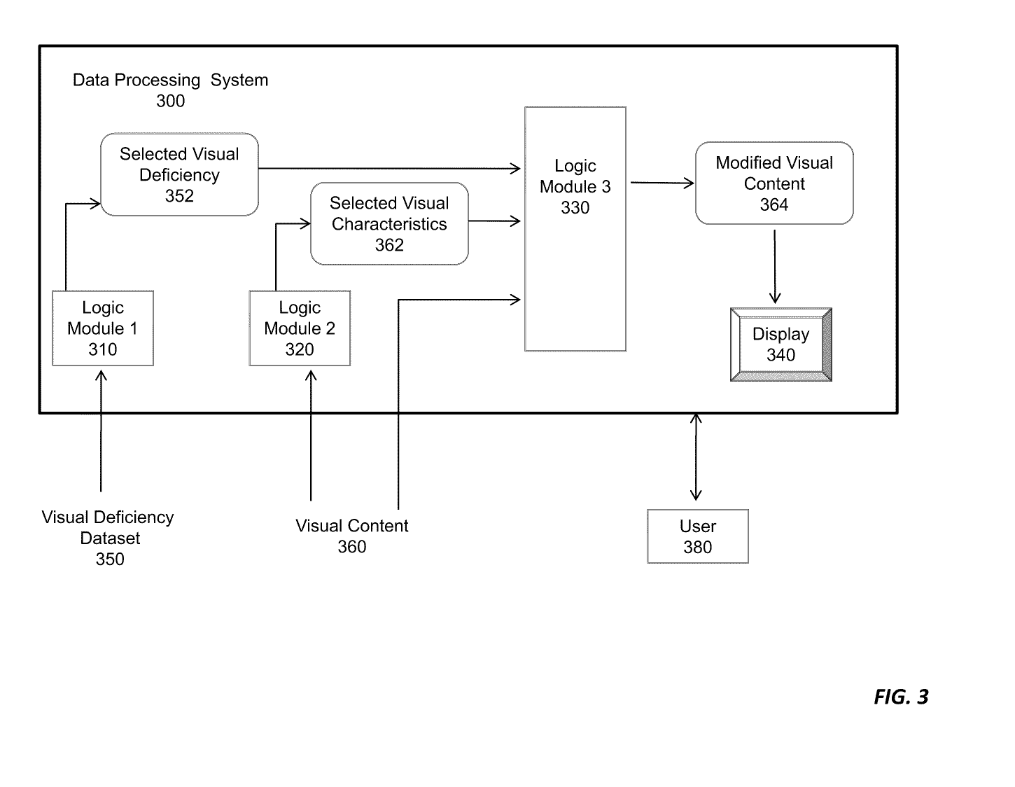

FIG. 3 shows an exemplary data processing system 300 configured to assist a visually-impaired user to view visual content, in accordance with an embodiment.

The exemplary data processing system 300 shown in the embodiment of FIG. 2 comprises logic module 1 310, logic module 2 320 and logic module 3 330 that are configured to perform various functions in connection with producing modified visual content 364, which may then be displayed on display 340 to be viewed by a user 380.

In one embodiment, logic module 1 310 is configured to receive information regarding one or more visual deficiencies, denoted in FIG. 3 as visual deficiency dataset 350.

For purposes of various embodiments, a visual deficiency means any disease or other condition that negatively affects human visual capacity, any combination of such diseases, any combination of such conditions, or any combination of such diseases and such conditions. Examples of visual deficiencies include (1) peripheral retinal function impairment conditions, and (2) macular impairment conditions, including the following:

(1) Peripheral retinal function impairment conditions: the following peripheral retinal function impairment conditions involve the loss or impairment of peripheral retinal function, where central vision may be less affected until later stages of disease:
(a) Retinitis Pigmentosa
(b) Glaucoma
(c) Choroideremia
(d) Congenital Retinal dystropies
(e) Usher's Disease

(2) Macular impairment conditions: the following macular impairment conditions involve loss or impairment of macula (central retina) functionality, which may lead to loss of fine visual acuity such as reading vision with normal fonts:
(a) Macular Degeneration
(b) Diabetic Macular Ischemia and edema
(c) Uveitic Macular edema
(d) Loss of Macular function from Retinal Artery and Venous Occlusions
(e) Stragardt's Disease
(f) Ocular Albinism
(g) Cone Rod dystrophy
(h) Best's Disease
(i) Retinopathy of Prematurity
(j) Congenital Retina Dystrophies
(k) Macular Ischemia secondary to stroke
(l) Histoplamosis
(m) Myopic degeneration
(n) Optic nerve hypoplasis
(o) Cone-Rod Dystropy

In one implementation, the visual deficiency dataset 350 consists of an identification of one or more visual deficiencies (e.g., using a name, a codename, a numerical identifier, a character identifier, a symbol identifier, or any combination of the foregoing or other identification marker). In an alternative implementation, the visual deficiency dataset 350 includes an identification of one or more visual deficiencies together with additional data relating to such visual deficiencies, such as an indication of the extent of a corresponding visual impairment and/or recommended corrective actions. In addition, the visual deficiency dataset can be configured to include additional specific user data such as the intraocular distance for calculating the correct stereoscopic distance adjustment, age, gender, and other patient medical conditions, such as Parkinson's syndrome, diabetes, or other medical conditions, that could be used to define or adjust the specific corrective actions applied to the visual content.

Upon receiving the visual deficiency dataset 350, the logic module 1 310 selects all or a part of the visual deficiency dataset 350 to produce the selected visual deficiency 352. In one implementation, the logic module 1 310 selects only one visual deficiency included in the visual deficiency dataset 350, with only a subset of the information relating to that visual deficiency that is included in the visual deficiency dataset 350. This may happen, for example, when the data processing system is configured to process only one visual deficiency at a time, and already includes specific corrective actions that it is prepared to undertake in response to the respective visual deficiency.

In one implementation, the logic module 1 310 selects only one visual deficiency included in the visual deficiency dataset 350, together with all the information relating to that visual deficiency that is included in the visual deficiency dataset 350. This may happen, for example, when the data processing system is configured to process only one visual deficiency at a time, but is prepared to implement, or at least to consider implementing any specific corrective actions identified in the visual deficiency dataset 350.

In one implementation, the logic module 1 310 selects more than one visual deficiency included in the visual deficiency dataset 350, together with all the information relating to each of those visual deficiencies that is included in the visual deficiency dataset 350. This may happen, for example, when the data processing system is configured to process one or more visual deficiencies at a time, and is prepared to implement, or at least to consider implementing any specific corrective actions identified in the visual deficiency dataset 350.

In general, the selected visual deficiency 352 may comprise one or more of the visual deficiencies included in the visual deficiency dataset 350, together with at least a subset of the information relating to each of those visual deficiencies that is included in the visual deficiency dataset 350.

In the embodiment of FIG. 3, at least part of the selected visual deficiency 352 is made available to the logic module 3 330 either by being transmitted directly or by being stored in a storage memory that is accessible to the logic module 3 330.

In the embodiment of FIG. 3, the logic module 2 320 receives certain visual content, denoted visual content 360. The logic module 2 320 selects a set of visual characteristics from the visual content 360, denoted in FIG. 3 as selected visual characteristics 362. In one implementation, the data processing system 300 will utilize the selected visual characteristics 362 as a basis for modifying the visual content 360 to compensate in whole or in part for at least one of the visual deficiencies experienced by user 380 and included in the selected visual deficiency 352.

Visual characteristics 362 may include various visual characteristics of the visual content 360 that can be modified to enhance the ability of the user 380 to view at least a portion of the visual content 360. Examples of such visual characteristics include:
the size of a letter, character, symbol or text string (e.g., font size);
the size of an image or graphic;
the stylistic representation of a letter, character, symbol or text string (e.g., italic or bold);
the type of font of a letter, character, symbol or text string (e.g., Arial, Times New Roman, rectangular segments or curved segments);
the color of a letter, character, symbol, text string or image;
the filler, texture or background of a letter, character, symbol, text string or image (e.g., a white or black filling of a letter, a background of a picture); and
the outline of a letter, character, symbol, text string or image (e.g., oversized contour lines for a capital letter “A”)
the three dimensional thickness of a letter, character, symbol, text string or image and its distance from the background

In the embodiment of FIG. 3, some or all of the visual content 360 is also made available to logic module 3 330 either by being transmitted directly or by being stored in a storage memory that is accessible to the logic module 3 330.

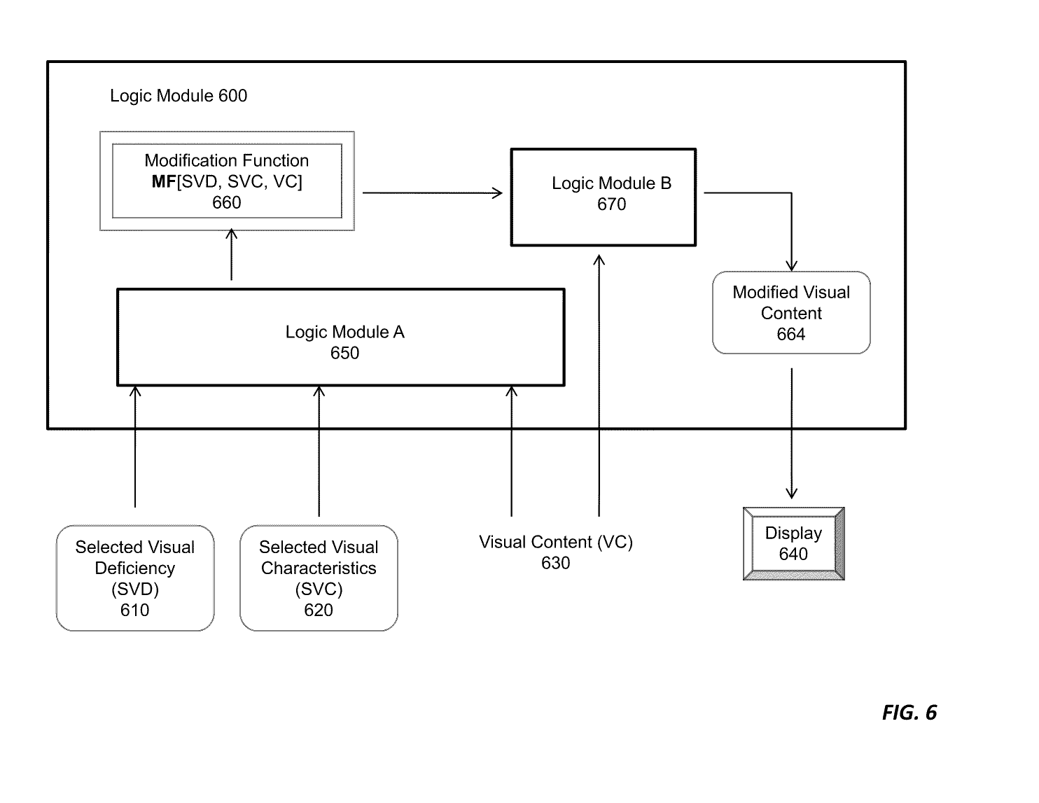

In the embodiment of FIG. 3, logic module 3 330 then uses at least a subset of the selected visual deficiency 352 and at least a subset of the selected visual characteristics 362 to process at least a subset of the visual content 360 to produce modified visual content, denoted in FIG. 3 as modified visual content 364. The modified visual content 364 produced by logic module 3 330 includes one or more modifications made to the visual content 360 in an attempt to enhance the ability of the user 380 to view and/or comprehend the visual content 360. A more detailed description of the architecture and functionality of an exemplary embodiment of the logic module 3 330 is provided in connection with FIG. 6.

The user 380 may be a visually-impaired medical patient under the care of a physician or of another health care provider, or may be a user that is not acting in a medical patient capacity but is operating the data processing system 300. In some circumstances, the user 380 may purchase or otherwise acquire the data processing system 300 in whole or in part as a result of a medical insurance program or as a result of a medical prescription made by a physician or another health care provider. In some circumstances, the user 380 may purchase or otherwise acquire the data processing system 300 directly. Various medical, governmental or private laws, rules or regulations may impact the way in which the user 380 purchases, leases or otherwise obtains access to the data processing system 300. Such laws, rules or regulations may vary from country to country, or even within industries, countries, states, regions or other geographic areas.

In the embodiment of FIG. 3, the modified visual content 364 may then be sent to the display 340, in whole or in part, to be displayed to the user 380. In one embodiment, all or part of the modified visual content 364 is not sent to the display 340 after it is produced, but is instead stored in a storage memory for possible use at a later time and/or for possible transmission to the display 340 at a later time. In one embodiment, all or part of the modified visual content 364 is both sent to the display 340 after it is produced and is stored in a storage memory for possible use at a later time and/or for possible transmission to the display 340 at a later time.

In the data processing system 300 described in connection with the embodiment of FIG. 3, logic module 1 310, logic module 2 320, logic module 3 330 and display 340 are independent modules and perform their respective functions independent of each other. In alternative embodiments, one or more of logic module 1 310, logic module 2 320, logic module 3 330 and display 340 may be combined in whole or in part in one or more logic modules that perform all or part of the functionality of each of the respectively combined modules. For example, logic module 1 310 and logic module 2 320 could be combined in a single logic module that is configured to perform the functionality of both logic module 1 310 and logic module 2 320, including producing all or part of the selected visual deficiency 352 and of the selected visual characteristics 362.

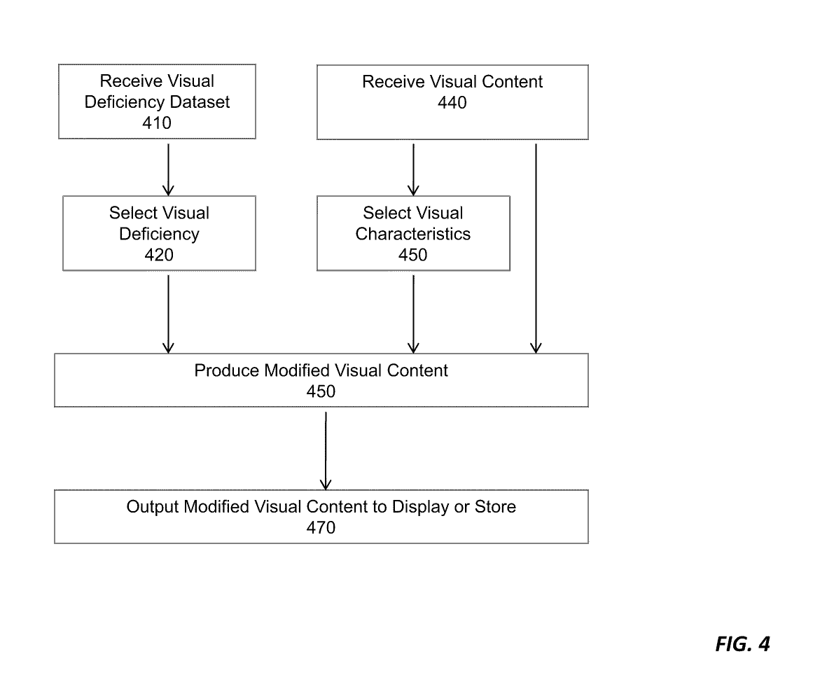

FIG. 4 shows a flowchart illustrating a method and process for the operation of an exemplary data processing system configured to assist a visually-impaired user to view visual content, in accordance with an embodiment. In one implementation, the set of steps shown in the embodiment of FIG. 4 may be performed with the data processing system 300 shown in FIG. 3, as described in more detail in connection with the embodiment of FIG. 3.

In the embodiment of FIG. 4, the exemplary data system receives a visual deficiency dataset at step 410. Based on the visual deficiency dataset received at step 410, the exemplary data system selects one or more visual deficiencies and related data at step 420 for further processing. These selected visual deficiencies and related data will help the exemplary data system to modify visual content in a way that addresses at least one visual deficiency that interferes with the user's ability to view the respective visual content.

At step 440, the exemplary data processing receives certain visual content intended to be displayed to visually-impaired user. At step 450, the exemplary data processing system selects a set of visual characteristics related to at least part of the visual content received at step 440.

At step 450, the exemplary data processing system receives one or more selected visual deficiencies and related data, at least a subset of the selected visual characteristics, and at least a portion of the visual content received at step 440, and produces modified visual content. At step 470, the modified visual content is transmitted to a display and/or is stored in a storage memory for subsequent use.

2. Intermediate Results Computed Externally

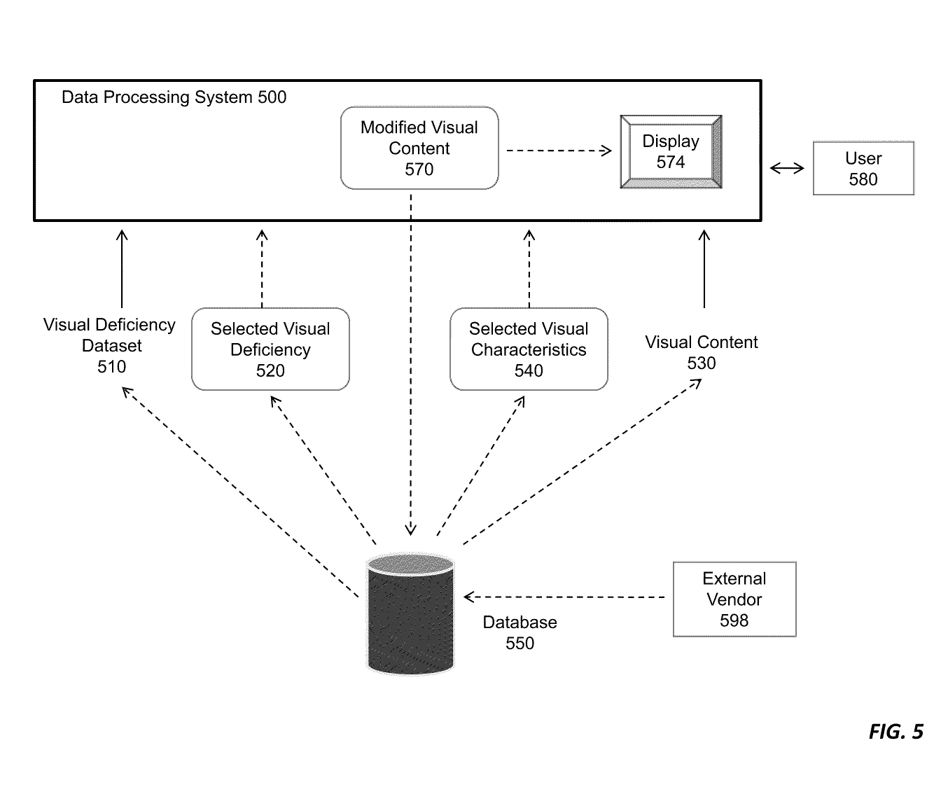

FIG. 5 shows an exemplary data processing system 500 configured to assist a visually-impaired user to view visual content, in accordance with an embodiment. In the embodiment of FIG. 5, the data processing system 500 performs a function similar to the function performed by the embodiments shown in FIG. 3 and FIG. 4, except that one or more of the intermediate results computed by the logic modules included in the data processing system 300 and respectively in the data processing system performing the steps of FIG. 4 are received from at least one external source, as opposed to being directly computed. More specifically, in the embodiment of FIG. 5, instead of being produced as intermediate results within the data processing system 300 or the data processing of FIG. 4, at least a subset of the selected visual deficiency 352 and/or at least a subset of the selected visual characteristics 362 are received from an external source. The external source may be the same source that provides the visual content 360 of FIG. 3 or the visual content received at step 440 in FIG. 4, or may be a different source. The external source may include (1) a secondary processor, (2) a cloud processor, (3) a multi-core processor, a (4) multi-processor system, and (5) a system of distributed processors on multiple computers via a processor sharing arrangement.

In the embodiment of FIG. 5, the data processing system 500 obtains visual deficiency dataset 510 and visual content 530, the intermediate results selected visual deficiency 520 and selected visual characteristics 540, and/or modified visual content 570 from an external source. The external source may be a database 550. Database 550 is hosted by a set of storage memories. In FIG. 5, the arrow lines connecting database 550 and visual deficiency dataset 510, selected visual deficiency 520, visual content 530 and selected visual characteristics 540 are dashed to emphasize that visual deficiency dataset 510 and the intermediate results may or may not be obtained from the database 550. In one implementation, if the data processing system 500 obtains the intermediate result selected visual deficiency 520 from an external source, it does not receive visual deficiency dataset 510. Analogously, in one implementation, if the data processing system 500 obtains the intermediate result selected visual characteristics 540 from an external source, it does not receive visual content 530 for purposes of determining that intermediate result, although it may still need to receive visual content 530 in order to produce modified content 570. In one implementation, the data processing system 500 obtains at least a portion of the modified content 570 from an external source, and it displays it on the display 574 and/or stores it in a storage memory.

In one implementation, external vendor 598 provides at least a subset of the visual deficiency dataset 510, selected visual deficiency 520, visual content 530 and/or selected visual characteristics 540 to the data processing system 500, and the data processing system 500 then produces modified content 570. For example, at least part of the selected visual deficiency 520 and/or selected visual characteristics 540 may be developed by the external vendor 598 and may be provided to the data processing system 500 and/or to user 580. This could be advantageous, for example, if the data processing system 500 will be processing some visual content that has already been analyzed at least in part by the external vendor 598, in which case the external vendor 598 would be able to provide at least partial intermediate results useful in the calculation of the modified content 570, and possibly even part or all of the modified content 570.

In one implementation, database 550 is completely included within the data processing system 500. In one implementation, database 550 is completely external to the data processing system 500, possibly stored on a storage memory attached to the data processing system 500 via a local connection (e.g., a USB or WiFi interface), or possibly stored on a storage memory coupled to the data processing system 500 via a network (e.g., a remote cloud-based memory volume). In one implementation, part of the database 550 is included within the data processing system 500, and part of the database 550 is external to the data processing system 500.

An advantage of determining at least some of the intermediate results selected visual deficiency 520 and selected visual characteristics 540 independent of the data processing system 500 is that the architecture and operation of the data processing system 500 may be simplified by reducing the need for determining such intermediate results when computing the modified content 570.

Another advantage of determining such intermediate results and/or modified content 570 independently and making them available to the data processing system is that at least some of the intermediate results and/or modified content 570 may be determined by an external vendor and provided to the data processing system 500 and/or to the user 580 on demand. Having an external vendor develop such intermediate results and/or modified content 570 independent of the operation of data processing system 500 may ensure a higher accuracy in the modified content 570 because the external vendor may have access to expanded computational power and/or may be able to develop more sophisticated models for the computation of such intermediate results and/or modified content 570.

In general, external vendor 598 may determine some or all of the intermediate results and/or modified content 570, and may make such determined intermediate results and/or modified content 570 available to the data processing system 500. In one implementation, external vendor 598 provides to data processing system 500 and/or to user 580 at least some of the intermediate results and/or modified content 570, either by storing them in database 550 or by transmitting them directly to the data processing system 500.

In one implementation, external vendor 598 manages database 550 by hosting the database 550 on a storage memory controlled by external vendor 598. In one implementation, external vendor 598 permits data processing system 500 and/or users 580 to access these intermediate results on demand from a storage memory controlled by the external vendor 598, using a login and password or another security or authorization framework (e.g., using an SSL secure protocol). In one implementation, the external vendor 598 is hosting these intermediate results on a website or on an electronic commerce portal accessible through a communication network. In one implementation, external vendor 598 provides at least some of the intermediate results and/or modified content 570 on a portable storage medium, such as a DVD or another optical medium, or on a portable storage drive (e.g., a USB flash memory drive).

In the embodiment of FIG. 5, the visual deficiency dataset 510, visual content 530, the intermediate results selected visual deficiency 520 and selected visual characteristics 540, and/or the modified visual content 570 may be in any data format as long as the format is recognized and can be processed by the data processing system 500 and/or by its constituent logic modules (if any). For example, some or all of the visual deficiency dataset 510, visual content 530, intermediate results selected visual deficiency 520 and selected visual characteristics 540, and/or modified visual content 570 may be encrypted, compressed, or formatted in a data file that complies with a specific protocol (e.g., XML).

As long as the intermediate results and other data received by the data processing system 500 are in a format that is recognized and can be processed by the data processing system 500 and/or by its constituent logic modules (if any), the intermediate results and such data are construed to be adapted to be used (or to be suitable to be used) by the data processing system 500 as a basis for the computation of the modified visual content 570 and/or for other operations performed by the data processing system 500, regardless of whether any such intermediate results or data may be further processed or combined with other data. For example, a particular visual characteristic included in the selected visual characteristics 540 may be formatted using a particular meta tag that is recognized by the data processing system 500, but the data processing system may need to extract only part of the data included in that visual characteristic (e.g., extracting just a color or a shape from the data received and corresponding to that visual characteristic). In general, as long as an intermediate result or other data is made available and is usable as a basis for the computation of the modified visual content 570 and/or other operations to be performed by the data processing system 500, such intermediate result and data are construed to be adapted for such use, regardless of whether the intermediate result or data is further processed and/or is combined with other intermediate results or other data.

In the embodiment of FIG. 5, intermediate results that are received from an external source are adapted to be used by the data processing system 500 as a basis for the computation of at least part of the modified visual content 570, which corresponds to at least part of the visual content 530.

3. Visual Content Modification Function

FIG. 6 illustrates the architecture and functionality of an exemplary embodiment of a logic module that processes visual content to produce modified visual content, in accordance with an embodiment.

In the embodiment of FIG. 6, a logic module 600 receives a set of inputs and processes visual content to produce modified visual content. In one implementation, the logic module 600 could be used to implement the logic module 3 330 discussed in connection with the embodiment of FIG. 3. In one embodiment, the logic module 600 could function as one or more logic modules incorporated in a data processing system. In another embodiment, the logic module 600 could itself be a data processing system.

The logic module 600 of FIG. 6 includes a logic module A 650 and a logic module B 670.

The logic module A 650 receives a set of selected visual deficiencies, illustrated in FIG. 6 as selected visual deficiency 610 and also denoted as SVD. In one implementation, the selected visual deficiency 610 is the selected visual deficiency 352 from the embodiment of FIG. 3.

The logic module A 650 also receives a set of selected visual characteristics, illustrated in FIG. 6 as selected visual characteristics 620 and also denoted as SVC. In one implementation, the selected visual characteristics 620 are the selected visual characteristics 362 from the embodiment of FIG. 3.

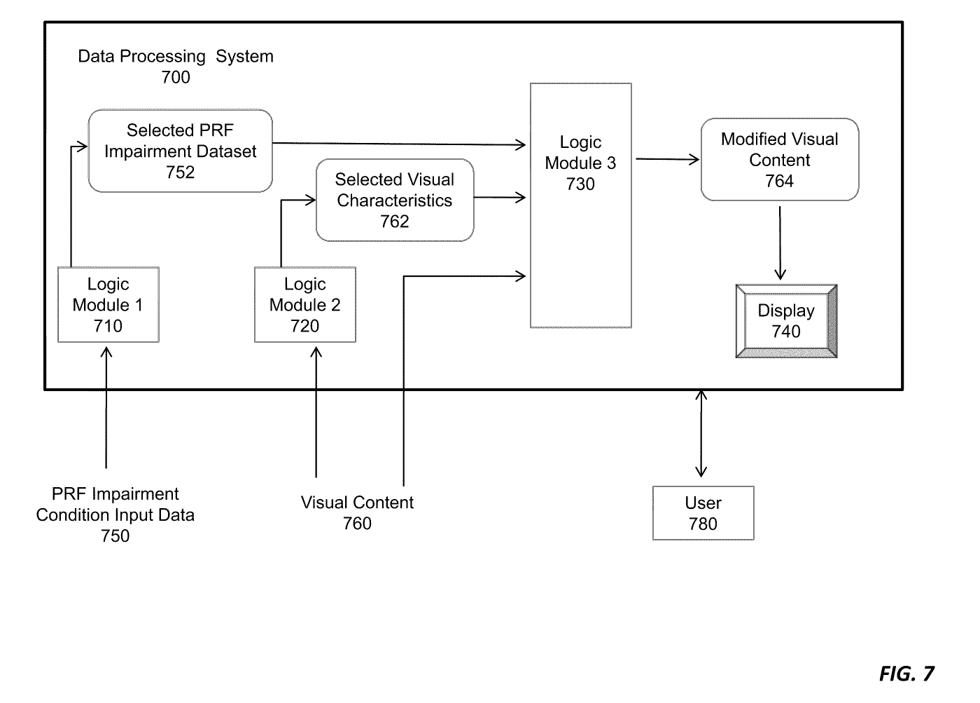

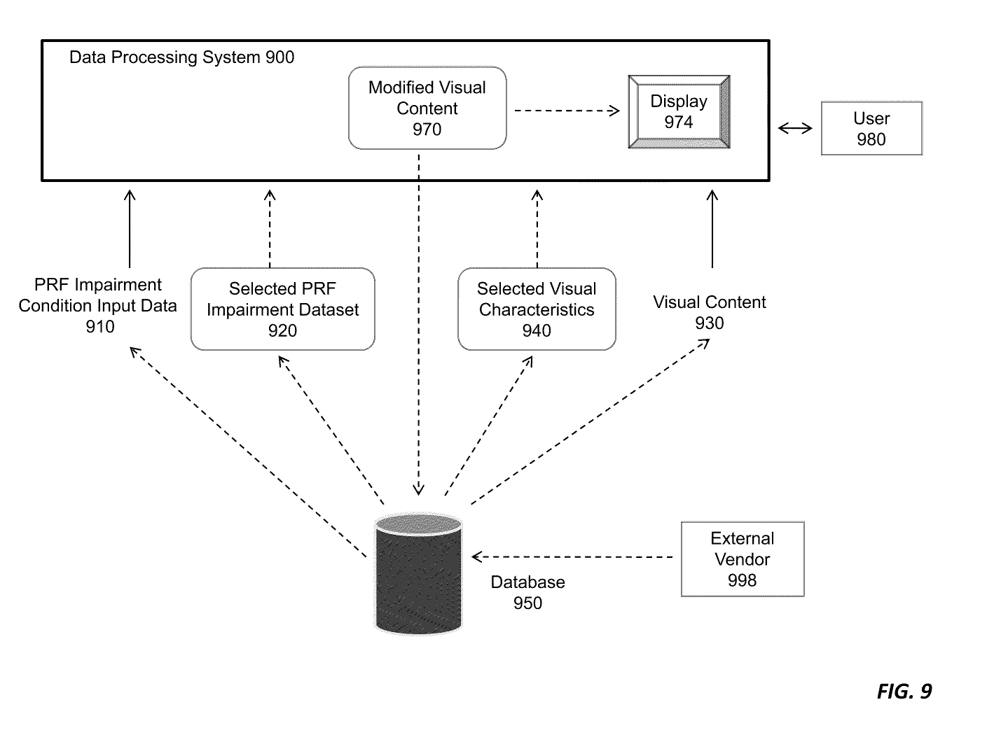

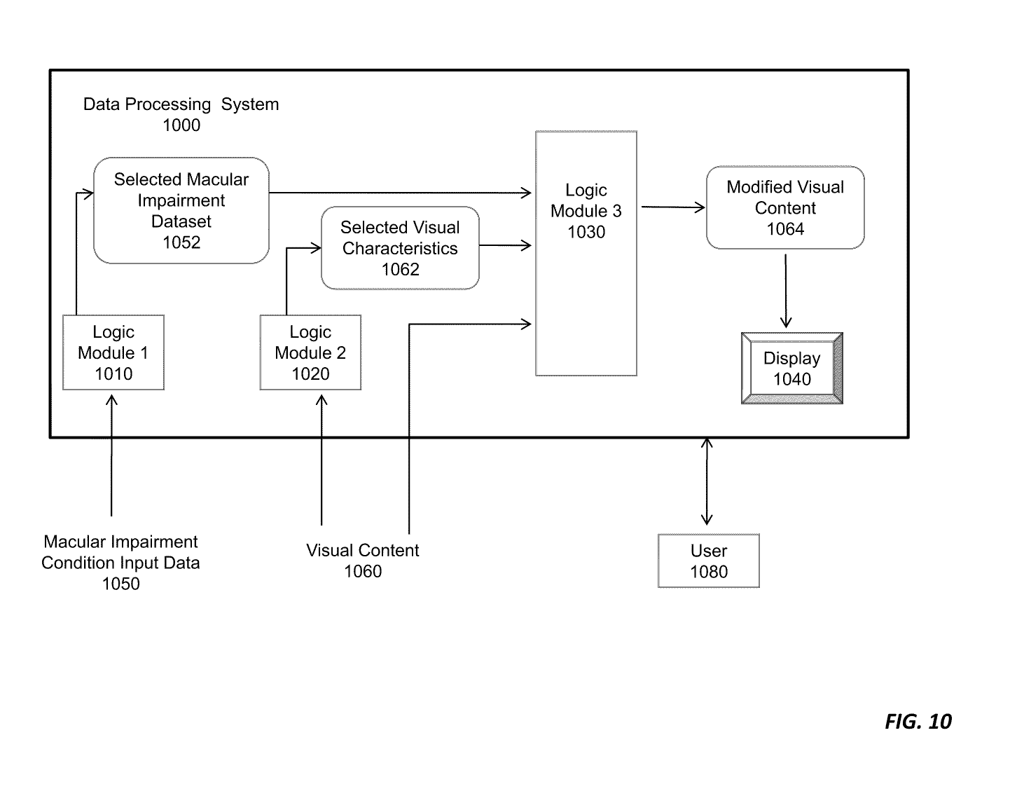

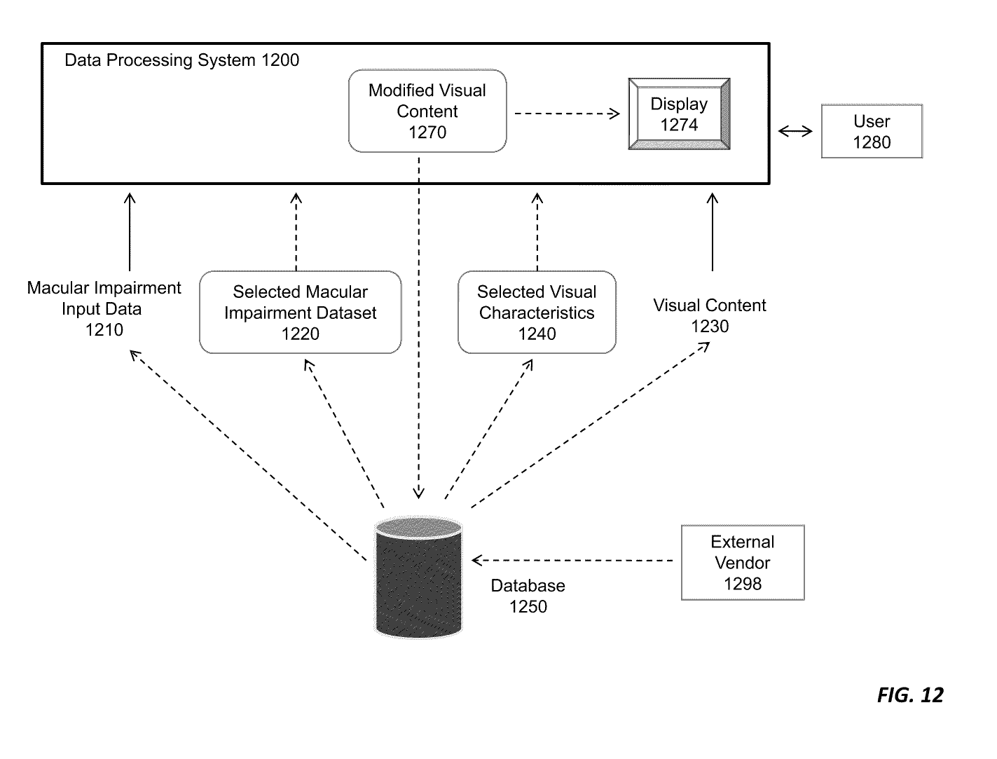

The logic module A 650 also receives certain visual content, illustrated in FIG. 6 as visual content 630 and also denoted VC. This is the initial visual content that is intended to be displayed in whole or in part to a user. When referring to this visual content that is processed by various embodiments of the invention, including the visual content 270 of FIG. 2, the visual content 360 of FIG. 3, the visual content 530 of FIG. 5, the visual content 630 of FIG. 6, the visual content 760 of FIG. 7, the visual content 930 of FIG. 9, the visual content 1060 of FIG. 10, and the visual content 1230 of FIG. 12, this visual content may also be denoted as the original visual content, the unmodified visual content, the unprocessed visual content, the underlying visual content, or by other similar terminology indicating that the respective visual content has not yet been processed to produce modified content that enhances the user's ability to understand and/or comprehend the respective initial visual content.

In the embodiment of FIG. 6, the logic module A 650 produces a modification function 660 based on at least part of the selected visual deficiency 610, at least part of selected visual characteristics 620 and at least part of visual content 630. The modification function 660 is also denoted in FIG. 6 as MF [SVD, SVC, VC], which denotes an analytic conversion function that operates using the three parameters SVD, SVC and VC.

The modification function 660 defines the nature and extent to which visual content will be modified to address one or more visual deficiencies of a user. In addition to the three parameters SVD, SVC and VC, the modification function 660 may also depend on additional parameters (e.g., the modification function 660 may change to also address preferences expressed by a user with respect to size, color or font of text).

The modification function 660 may remain substantially the same for a broader range of visual content (e.g., for a whole page of text that is processed by logic module A 650), or may be changing dynamically on a character-by-character basis (e.g., the modification function 660 may dynamically correct detected hand tremors of the user that are inducing physical movement of the display on which the modified visual content is displayed).

In one implementation, the modification function 660 has the attributes of a transfer function as more generally known in the area of digital signal processing or control theory. In general, in the areas of signal processing or control theory, a transfer function (also sometimes called a network function) provides a mathematical or functional mapping, in terms of spatial or temporal frequency, between the input and output of a system. For multiple inputs and outputs, the input-output mapping may be described using a set (e.g., a vector or matrix) of transfer functions.

In the embodiment of FIG. 6, logic module B 670 receives the modification function 660 and uses it to operate on at least a subset of the visual content 630, therefore producing modified visual content 664. In one implementation, the logic module B 670 is continuously receiving visual content 664 and is producing dynamically modified visual content 664, which is then directly transmitted to the display 640. In one implementation, the logic module B 670 processes visual content 664 to produce modified visual content 664, which is then stored in a storage memory.

By analogy to the area of signal processing, the operation of logic module B 670 is similar to the operation of a logic module that applies a transfer function (e.g., the modification function 660) to an input signal (e.g., the visual content 630) to produce the output signal (e.g., the modified visual content 664). The modified visual content 664 is then transmitted to the display 640.

### B. Peripheral Retinal Function Impairment Condition Exemplary Embodiment

1. Architecture and Process Flow

FIG. 7 shows an exemplary data processing system 700 configured to assist a visually-impaired user that is affected by a peripheral retinal function impairment condition to view visual content, in accordance with an embodiment of the present invention.

In general, peripheral retinal function impairment conditions, also denoted PRF impairment conditions, involve the loss or impairment of peripheral retinal function of the eye, where central vision may be less affected until later stages of disease. Examples of PRF impairment conditions include:
(a) Retinitis Pigmentosa
(b) Glaucoma
(c) Choroideremia
(d) Congenital Retinal dystropies
(e) Usher's Disease

The exemplary data processing system 700 shown in the embodiment of FIG. 7 comprises logic module 1 710, logic module 2 720 and logic module 3 730 that are configured to perform various functions in connection with producing modified visual content 764, which may then be displayed on display 740 to be viewed by a user 780.

In one embodiment, logic module 1 710 is configured to receive a set of input data describing a macular impairment condition that is affecting the user 780. This set of input data relating to the macular impairment condition is denoted in FIG. 7 as macular impairment condition input data 750.

A symptom of some PRF impairment conditions may be tunnel vision. In general, tunnel vision is a condition that affects humans and decreases visual acuity. A human affected by a tunnel vision condition may experience a collapse or narrowing of the field of view in one or both eyes as a result of loss of peripheral receptors on the retina. Such a loss may result in one or more smaller islands of vision, forcing the patient to turn the patient's head to compensate. Eye saccades present in normal reading may no longer be possible with the loss of a part or all of the peripheral visual field.

In one implementation, the PRF impairment condition input data 750 consists of an identification of a PRF impairment condition (e.g., a name, a codename, a numerical identifier, a character identifier, a symbol identifier, or any combination of the foregoing or other identification marker). In an alternative implementation, the PRF impairment condition input data 750 includes an identification of a PRF impairment condition together with additional data relating to that PRF impairment condition, such as an indication of the extent of a corresponding visual impairment and/or recommended corrective actions. In one embodiment, the extent of visual field dropout may be assessed by visual field testing such as Humphrey, Octupus or Goldmann visual field testing. Resulting data may then be used to formulate an appropriate algorithm for visual reading assistance.

Upon receiving the PRF impairment condition input data 750, the logic module 1 710 selects all or a part of the PRF impairment condition input data 750 to produce a selected PRF impairment dataset 752. In one implementation, the logic module 1 710 selects only a subset of the information relating to that PRF impairment condition that is included in the PRF impairment condition input data 750. This may happen, for example, when the data processing system has already received specific corrective actions that it may undertake in response to the tunnel vision condition.

In one implementation, the logic module 1 710 selects all the information relating to the tunnel vision condition that is included in the PRF impairment condition input data 750. This may happen, for example, when the data processing system is prepared to implement, or at least to consider implementing any specific corrective actions identified in the PRF impairment condition input data 750.

In general, the selected PRF impairment dataset 752 may comprise one or more of the tunnel vision conditions included in the PRF impairment condition input data 750, together with at least a subset of the information relating to each of those PRF impairment conditions that is included in the PRF impairment condition input data 750.

In the embodiment of FIG. 7, at least part of the selected PRF impairment dataset 752 is made available to the logic module 3 730 either by being transmitted directly or by being stored in a storage memory that is accessible to the logic module 3 730.

In the embodiment of FIG. 7, the logic module 2 720 receives certain visual content, denoted visual content 760. The logic module 2 720 selects a set of visual characteristics from the visual content 760, denoted in FIG. 7 as selected visual characteristics 762. In one implementation, the data processing system 700 will utilize the selected visual characteristics 762 as a basis for modifying the visual content 760 to compensate in whole or in part for at least one of the visual deficiencies experienced by user 780 and included in the selected PRF impairment dataset 752.

Visual characteristics 762 may include various visual characteristics of the visual content 760 that can be modified to enhance the ability of the user 780 to view at least a portion of the visual content 760. Examples of such visual characteristics include:
the size of a letter, character, symbol, word or text string (e.g., font size);
the size of an image or graphic;
the stylistic representation of a letter, character, symbol, word or text string (e.g., italic or bold);
the type of font of a letter, character, symbol, word or text string (e.g., Arial, Times New Roman, rectangular segments or curved segments);
the color of a letter, character, symbol, word, text string or image;
the filler, texture or background of a letter, character, symbol, word, text string or image (e.g., a white or black filling of a letter, a background of a picture); and
the outline of a letter, character, symbol, word, text string or image (e.g., oversized contour lines for a capital letter “A”)

In the embodiment of FIG. 7, some or all of the visual content 760 is also made available to logic module 3 730 either by being transmitted directly or by being stored in a storage memory that is accessible to the logic module 3 730.

In the embodiment of FIG. 7, logic module 3 730 then uses at least a subset of the selected PRF impairment dataset 752 and at least a subset of the selected visual characteristics 762 to process at least a subset of the visual content 760 to produce modified visual content, denoted in FIG. 7 as modified visual content 764. The modified visual content 764 produced by logic module 3 730 includes one or more modifications made to the visual content 760 in an attempt to enhance the ability of the user 780 to view and/or comprehend the visual content 760. A more detailed description of the architecture and functionality of an exemplary embodiment of the logic module 3 730 was provided in connection with FIG. 6.

In various implementations, the logic module 3 730 performs one or more of the following actions:
(a) compression of at least a subset of the visual content 760;
(b) warping of at least a subset of the visual content 760;
(c) compression, magnification and/or warping of text included in the visual content 760;
(d) compression, magnification and/or warping of at least a portion of an image included in the visual content 760;
(e) scrolling through the active field of view of the user 780 of compressed text, magnified text, or warped text included in the visual content 760;
(f) scrolling through the active field of view of the user 780 of at least a portion of a compressed image, magnified image, or warped image included in the visual content 760; or
(g) modification of at least one contrast setting of at least a subset of the visual content 760.

In the embodiment of FIG. 7, the modified visual content 764 may then be sent to the display 740, in whole or in part, to be displayed to the user 780. In one embodiment, all or part of the modified visual content 764 is not sent to the display 740 after it is produced, but is instead stored in a storage memory for possible use at a later time and/or for possible transmission to the display 740 at a later time. In one embodiment, all or part of the modified visual content 764 is both sent to the display 740 after it is produced and is stored in a storage memory for possible use at a later time and/or for possible transmission to the display 740 at a later time.

In the data processing system 700 described in connection with the embodiment of FIG. 7, logic module 1 710, logic module 2 720, logic module 3 730 and display 740 are independent modules and perform their respective functions independent of each other. In alternative embodiments, one or more of logic module 1 710, logic module 2 720, logic module 3 730 and display 740 may be combined in whole or in part in one or more logic modules that perform all or part of the functionality of each of the respectively combined modules. For example, logic module 1 710 and logic module 2 720 could be combined in a single logic module that is configured to perform the functionality of both logic module 1 710 and logic module 2 720, including producing all or part of the selected PRF impairment dataset 752 and of the selected visual characteristics 762.

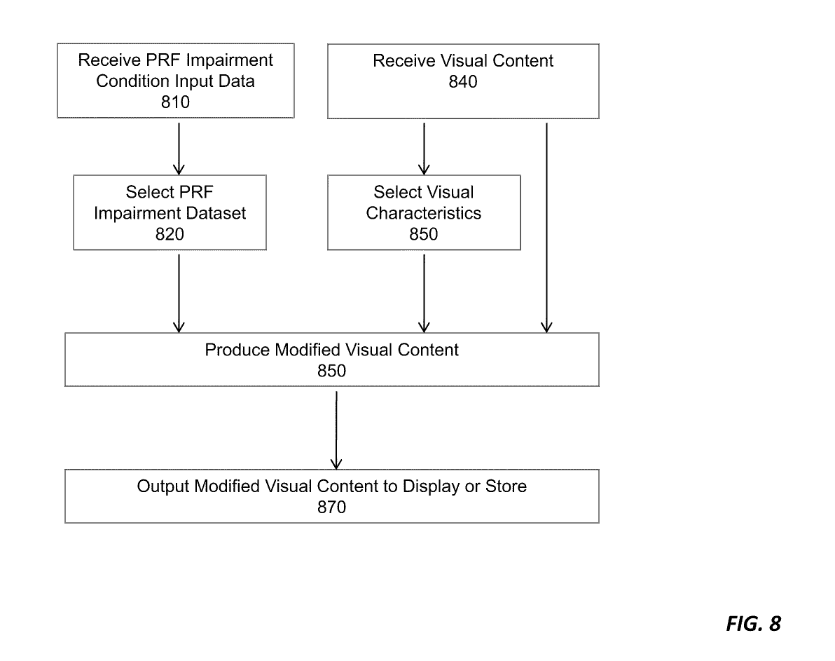

FIG. 8 shows a flowchart illustrating a method and process for the operation of an exemplary data processing system configured to assist a visually-impaired user that is affected by a PRF impairment condition to view visual content, in accordance with an embodiment. In one implementation, the set of steps shown in the embodiment of FIG. 8 may be performed with the data processing system 700 shown in FIG. 7, as described in more detail in connection with the embodiment of FIG. 7.

In the embodiment of FIG. 8, the exemplary data system receives a set of PRF impairment condition input data at step 810. Based on the PRF impairment condition input data received at step 810, the exemplary data system selects a PRF impairment condition dataset at step 820 for further processing. This PRF impairment condition dataset will help the exemplary data system to modify visual content in a way that addresses at least one visual deficiency related to the user's PRF impairment condition that interferes with the user's ability to view the respective visual content.

At step 840, the exemplary data processing receives certain visual content intended to be displayed to visually-impaired user. At step 850, the exemplary data processing system selects a set of visual characteristics related to at least part of the visual content received at step 840.

At step 850, the exemplary data processing system receives at least part of the PRF impairment condition input data, at least a subset of the PRF impairment condition dataset, and at least a portion of the visual content received at step 840, and produces modified visual content. At step 870, the modified visual content is transmitted to a display and/or is stored in a storage memory for subsequent use.

2. Intermediate Results Computed Externally

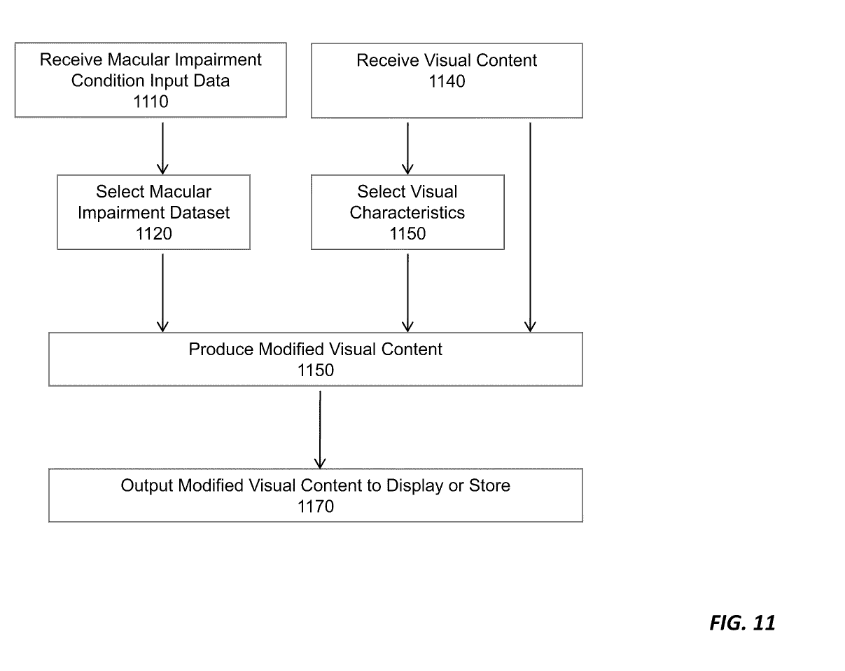

FIG. 9 shows an exemplary data processing system 900 configured to assist a visually-impaired user affected by a PRF impairment condition to view visual content, in accordance with an embodiment. In the embodiment of FIG. 9, the data processing system 900 performs a function similar to the function performed by the embodiments shown in FIG. 7 and FIG. 11, except that one or more of the intermediate results computed by the logic modules included in the data processing system 700 and respectively in the data processing system performing the steps of FIG. 11 are received from at least one external source, as opposed to being directly computed. More specifically, in the embodiment of FIG. 9, instead of being produced as intermediate results within the data processing system 700 or within the data processing of FIG. 11, at least a subset of the selected PRF impairment dataset 752 and/or at least a subset of the selected visual characteristics 762 are received from an external source. The external source may be the same source that provides the visual content 760 of FIG. 7 or the visual content received at step 1140 in FIG. 11, or may be a different source.

In the embodiment of FIG. 9, the data processing system 900 obtains PRF impairment condition input data 910 and visual content 930, the intermediate results selected PRF impairment dataset 920 and selected visual characteristics 940, and/or modified visual content 970 from an external source. The external source may be a database 950. Database 950 is hosted by a set of storage memories. In FIG. 9, the arrow lines connecting database 950 and PRF impairment condition input data 910, selected PRF impairment dataset 920, visual content 930 and selected visual characteristics 940 are dashed to emphasize that PRF impairment condition input data 910, visual content 930 and the intermediate results may or may not be obtained from the database 950. In one implementation, if the data processing system 900 obtains the intermediate result selected PRF impairment dataset 920 from an external source, it does not receive PRF impairment condition input data 910. Analogously, in one implementation, if the data processing system 900 obtains the intermediate result selected visual characteristics 940 from an external source, it does not receive visual content 930 for purposes of determining that intermediate result, although it may still need to receive visual content 930 in order to produce modified content 970. In one implementation, the data processing system 900 obtains at least a portion of the modified content 970 from an external source, and it displays it on the display 974 and/or stores it in a storage memory.

In one implementation, external vendor 998 provides at least a subset of the PRF impairment condition input data 910, selected PRF impairment dataset 920, visual content 930 and/or selected visual characteristics 940 to the data processing system 900, and the data processing system 900 then produces modified content 970. For example, at least part of the selected PRF impairment dataset 920 and/or selected visual characteristics 940 may be developed by the external vendor 998 and may be provided to the data processing system 900 and/or to user 980. This could be advantageous, for example, if the data processing system 900 will be processing some visual content that has already been analyzed at least in part by the external vendor 998, in which case the external vendor 998 would be able to provide at least partial intermediate results, and possibly even part or all of the modified content 970.

In one implementation, database 950 is completely included within the data processing system 900. In one implementation, database 950 is completely external to the data processing system 950, possibly stored on a storage memory attached to the data processing system 900 via a local connection (e.g., a USB or WiFi interface), or possibly stored on a storage memory coupled to the data processing system 900 via a network (e.g., a remote cloud-based memory volume). In one implementation, part of the database 950 is included within the data processing system 900, and part of the database 950 is external to the data processing system 950.

An advantage of determining at least some of the intermediate results selected PRF impairment dataset 920 and selected visual characteristics 940 independent of the data processing system 900 is that the architecture and operation of the data processing system 900 may be simplified by reducing the need for determining such intermediate results when computing the modified content 970.

Another advantage of determining such intermediate results and/or modified content 970 independently and making them available to the data processing system is that at least some of the intermediate results and/or modified content 970 may be determined by an external vendor and provided to the data processing system 900 and/or to the user 980 on demand. Having an external vendor develop such intermediate results and/or modified content 970 independent of the operation of data processing system 900 may ensure a higher accuracy in the modified content 970 because the external vendor may have access to expanded computational power and/or may be able to develop more sophisticated models for the computation of such intermediate results and/or modified content 970.

In general, external vendor 998 may determine some or all of the intermediate results and/or modified content 970, and may make such determined intermediate results and/or modified content 970 available to the data processing system 900. In one implementation, external vendor 998 provides to data processing system 900 and/or to user 980 at least some of the intermediate results and/or modified content 970, either by storing them in database 950 or by transmitting them directly to the data processing system 900.

In one implementation, external vendor 998 manages database 950 by hosting the database 950 on a storage memory controlled by external vendor 998. In one implementation, external vendor 998 permits data processing system 900 and/or users 980 to access these intermediate results on demand from a storage memory controlled by the external vendor 998, using a login and password or another security or authorization framework (e.g., using an SSL secure protocol). In one implementation, the external vendor 998 is hosting these intermediate results on a website or on an electronic commerce portal accessible through a communication network. In one implementation, external vendor 998 provides at least some of the intermediate results and/or modified content 970 on a portable storage medium, such as a DVD or another optical medium, or on a portable storage drive (e.g., a USB flash memory drive).

In the embodiment of FIG. 9, the PRF impairment condition input data 910, visual content 930, the intermediate results selected PRF impairment dataset 920 and selected visual characteristics 940, and/or the modified visual content 970 may be in any data format as long as the format is recognized and can be processed by the data processing system 900 and/or by its constituent logic modules (if any). For example, some or all of the PRF impairment condition input data 910, visual content 930, intermediate results selected PRF impairment dataset 920 and selected visual characteristics 940, and/or modified visual content 970 may be encrypted, compressed, or formatted in a data file that complies with a specific protocol (e.g., XML).

As long as the intermediate results and other data received by the data processing system 900 are in a format that is recognized and can be processed by the data processing system 900 and/or by its constituent logic modules (if any), the intermediate results and such data are construed to be adapted to be used (or to be suitable to be used) by the data processing system 900 as a basis for the computation of the modified visual content 970 and/or for other operations performed by the data processing system 900, regardless of whether any such intermediate results or data may be further processed or combined with other data. For example, a particular visual characteristic included in the selected visual characteristics 940 may be formatted using a particular meta tag that is recognized by the data processing system 900, but the data processing system may need to extract only part of the data included in that visual characteristic (e.g., extracting just a color or a shape from the data received and corresponding to that visual characteristic). In general, as long as an intermediate result or other data is made available and is usable as a basis for the computation of the modified visual content 970 and/or other operations to be performed by the data processing system 900, such intermediate result and data are construed to be adapted for such use, regardless of whether the intermediate result or data is further processed and/or is combined with other intermediate results or other data.

In the embodiment of FIG. 9, intermediate results that are received from an external source are adapted to be used by the data processing system 900 as a basis for the computation of at least part of the modified visual content 970, which corresponds to at least part of the visual content 930.

### C. Macular Impairment Condition Exemplary Embodiment

1. Architecture and Process Flow

FIG. 10 shows an exemplary data processing system 1000 configured to assist a visually-impaired user that is affected by a macular impairment condition to view visual content, in accordance with an embodiment of the present invention.

In general, macular impairment conditions are conditions that involve loss or impairment of macula (central retina) functionality, which may lead to loss of fine visual acuity such as reading vision with normal fonts. Examples of macular impairment conditions include:
(a) Macular Degeneration
(b) Diabetic Macular Ischemia and edema
(c) Uveitic Macular edema
(d) Loss of Macular function from Retinal Artery and Venous Occlusions
(e) Stragardt's Disease
(f) Ocular Albinism
(g) Cone Rod dystrophy
(h) Best's Disease
(i) Retinopathy of Prematurity
(j) Congenital Retina Dystrophies
(k) Macular Ischemia secondary to stroke
(l) Histoplamosis
(m) Myopic degeneration
(n) Optic nerve hypoplasia
(o) Cone-Rod Dystropy

The exemplary data processing system 1000 shown in the embodiment of FIG. 10 comprises logic module 1 1010, logic module 2 1020 and logic module 3 1030 that are configured to perform various functions in connection with producing modified visual content 1064, which may then be displayed on display 1040 to be viewed by a user 1080.

In one embodiment, logic module 1 1010 is configured to receive a set of input data describing a macular impairment condition that is affecting the user 1080. This set of input data relating to the macular impairment condition is denoted in FIG. 10 as macular impairment condition input data 1050.

An example of a macular impairment condition is macular degeneration. In general, macular degeneration is a condition that affects humans and decreases visual acuity. A human affected by a macular degeneration condition may experience loss of vision in one or both eyes as a result of blind spots caused by retinal photoreceptors that have been damaged. As an analogy with an imaging sensor in the art of digital image capture, macular degeneration could be described as a condition where some of the human eye's retina's pixels (i.e., a pixel is being compared to a photoreceptor cone in the human retina) are missing or are functioning with reduced efficiency. Such cones, or pixels, may be partially functional, or may have been completely destroyed, therefore producing a complete loss of vision in specific spots, a partial reduction in the capacity to see in specific spots, or a combination of the foregoing. Macular degeneration often affects the central fovea of the retina, which is an area that may be primarily used for reading and other tasks requiring fine visual discrimination. The peripheral areas of the retina may often remain substantially intact.

In one implementation, the macular impairment condition input data 1050 consists of an identification of a macular impairment condition (e.g., a name, a codename, a numerical identifier, a character identifier, a symbol identifier, or any combination of the foregoing or other identification marker). In an alternative implementation, the macular impairment condition input data 1050 includes an identification of a macular impairment condition together with additional data relating to that macular impairment condition, such as an indication of the extent of a corresponding visual impairment and/or recommended corrective actions.

In one embodiment, the extent of central visual destruction can be assessed using a micoperimetry technique to map any central blind spots present. From the size of the mapped scotoma, adjustments may be made to the respective visual content such that the visual content of interest may be exposed to healthier photoreceptors. In one implementation, visual content is presented eccentric to the user's point of fixation to make it possible for healthier photoreceptors to view the respective visual content, which may reduce or preclude the need for the user to have to turn the user's head to view the visual content.

Upon receiving the macular impairment condition input data 1050, the logic module 1 1010 selects all or a part of the macular impairment condition input data 1050 to produce a selected macular impairment dataset 1052. In one implementation, the logic module 1 1010 selects only a subset of the information relating to that macular impairment condition that is included in the macular impairment condition input data 1050. This may happen, for example, when the data processing system has already received specific corrective actions that it is may undertake in response to the macular impairment condition.

In one implementation, the logic module 1 1010 selects all the information relating to the macular impairment condition that is included in the macular impairment condition input data 1050. This may happen, for example, when the data processing system is prepared to implement, or at least to consider implementing any specific corrective actions identified in the macular impairment condition input data 1050.

In general, the selected macular impairment dataset 1052 may comprise one or more of the macular impairment conditions included in the macular impairment condition input data 1050, together with at least a subset of the information relating to each of those macular impairment conditions that is included in the macular impairment condition input data 1050.

In the embodiment of FIG. 10, at least part of the selected macular impairment dataset 1052 is made available to the logic module 3 1030 either by being transmitted directly or by being stored in a storage memory that is accessible to the logic module 3 1030.

In the embodiment of FIG. 10, the logic module 2 1020 receives certain visual content, denoted visual content 1060. The logic module 2 1020 selects a set of visual characteristics from the visual content 1060, denoted in FIG. 10 as selected visual characteristics 1062. In one implementation, the data processing system 1000 will utilize the selected visual characteristics 1062 as a basis for modifying the visual content 1060 to compensate in whole or in part for at least one of the visual deficiencies experienced by user 1080 and included in the selected macular impairment dataset 1052.

Visual characteristics 1062 may include various visual characteristics of the visual content 1060 that can be modified to enhance the ability of the user 1080 to view at least a portion of the visual content 1060. Examples of such visual characteristics include:
the size of a letter, character, symbol, word or text string (e.g., font size);
the size of an image or graphic;
the stylistic representation of a letter, character, symbol, word or text string (e.g., italic or bold);
the type of font of a letter, character, symbol, word or text string (e.g., Arial, Times New Roman, rectangular segments or curved segments);
the color of a letter, character, symbol, word, text string or image;
the filler, texture or background of a letter, character, symbol, word, text string or image (e.g., a white or black filling of a letter, a background of a picture); and
the outline of a letter, character, symbol, word, text string or image (e.g., oversized contour lines for a capital letter “A”)

In the embodiment of FIG. 10, some or all of the visual content 1060 is also made available to logic module 3 1030 either by being transmitted directly or by being stored in a storage memory that is accessible to the logic module 3 1030.

In the embodiment of FIG. 10, logic module 3 1030 then uses at least a subset of the selected macular impairment dataset 1052 and at least a subset of the selected visual characteristics 1062 to process at least a subset of the visual content 1060 to produce modified visual content, denoted in FIG. 10 as modified visual content 1064. The modified visual content 1064 produced by logic module 3 1030 includes one or more modifications made to the visual content 1060 in an attempt to enhance the ability of the user 1080 to view and/or comprehend the visual content 1060. A more detailed description of the architecture and functionality of an exemplary embodiment of the logic module 3 1030 was provided in connection with FIG. 6.

In various implementations, the logic module 3 1030 performs one or more of the following actions:
(a) remapping of at least a subset of the visual content 1060 around limited vision spots in the visual field of the user 1080;
(b) alteration of one or more colors of at least a subset of the visual content 1060; or
(c) remapping of at least a subset of the visual content 1060 around decreased acuity spots in the visual field of the user 1080.

In the embodiment of FIG. 10, the modified visual content 1064 may then be sent to the display 1040, in whole or in part, to be displayed to the user 1080. In one embodiment, all or part of the modified visual content 1064 is not sent to the display 1040 after it is produced, but is instead stored in a storage memory for possible use at a later time and/or for possible transmission to the display 1040 at a later time. In one embodiment, all or part of the modified visual content 1064 is both sent to the display 1040 after it is produced and is stored in a storage memory for possible use at a later time and/or for possible transmission to the display 1040 at a later time.

In the data processing system 1000 described in connection with the embodiment of FIG. 10, logic module 1 1010, logic module 2 1020, logic module 3 1030 and display 1040 are independent modules and perform their respective functions independent of each other. In alternative embodiments, one or more of logic module 1 1010, logic module 2 1020, logic module 3 1030 and display 1040 may be combined in whole or in part in one or more logic modules that perform all or part of the functionality of each of the respectively combined modules. For example, logic module 1 1010 and logic module 2 1020 could be combined in a single logic module that is configured to perform the functionality of both logic module 1 1010 and logic module 2 1020, including producing all or part of the selected macular impairment dataset 1052 and of the selected visual characteristics 1062.

FIG. 11 shows a flowchart illustrating a method and process for the operation of an exemplary data processing system configured to assist a visually-impaired user that is affected by a macular impairment condition to view visual content, in accordance with an embodiment of the present invention. In one implementation, the set of steps shown in the embodiment of FIG. 11 may be performed with the data processing system 1000 shown in FIG. 10, as described in more detail in connection with the embodiment of FIG. 10.

In the embodiment of FIG. 11, the exemplary data system receives a set of macular impairment condition input data at step 1110. Based on the macular impairment condition input data received at step 1110, the exemplary data system selects a macular impairment condition dataset at step 1120 for further processing. This macular impairment condition dataset will help the exemplary data system to modify visual content in a way that addresses at least one visual deficiency related to the user's macular impairment condition that interferes with the user's ability to view the respective visual content.

At step 1140, the exemplary data processing receives certain visual content intended to be displayed to visually-impaired user. At step 1150, the exemplary data processing system selects a set of visual characteristics related to at least part of the visual content received at step 1140.

At step 1150, the exemplary data processing system receives at least part of the macular impairment condition input data, at least a subset of the macular impairment condition dataset, and at least a portion of the visual content received at step 1140, and produces modified visual content. At step 1170, the modified visual content is transmitted to a display and/or is stored in a storage memory for subsequent use.

2. Intermediate Results Computed Externally

FIG. 12 shows an exemplary data processing system 1200 configured to assist a visually-impaired user affected by a macular impairment condition to view visual content, in accordance with an embodiment of the present invention. In the embodiment of FIG. 12, the data processing system 1200 performs a function similar to the function performed by the embodiments shown in FIG. 10 and FIG. 11, except that one or more of the intermediate results computed by the logic modules included in the data processing system 1000 and respectively in the data processing system performing the steps of FIG. 11 are received from at least one external source, as opposed to being directly computed. More specifically, in the embodiment of FIG. 12, instead of being produced as intermediate results within the data processing system 1000 or within the data processing of FIG. 11, at least a subset of the selected macular impairment dataset 1052 and/or at least a subset of the selected visual characteristics 1062 are received from an external source. The external source may be the same source that provides the visual content 1060 of FIG. 10 or the visual content received at step 1140 in FIG. 11, or may be a different source.

In the embodiment of FIG. 12, the data processing system 1200 obtains macular impairment condition input data 1210 and visual content 1230, the intermediate results selected macular impairment dataset 1220 and selected visual characteristics 1240, and/or modified visual content 1270 from an external source. The external source may be a database 1250. Database 1250 is hosted by a set of storage memories. In FIG. 12, the arrow lines connecting database 1250 and macular impairment condition input data 1210, selected macular impairment dataset 1220, visual content 1230 and selected visual characteristics 1240 are dashed to emphasize that macular impairment condition input data 1210, visual content 1230 and the intermediate results may or may not be obtained from the database 1250. In one implementation, if the data processing system 1200 obtains the intermediate result selected macular impairment dataset 1220 from an external source, it does not receive macular impairment condition input data 1210. Analogously, in one implementation, if the data processing system 1200 obtains the intermediate result selected visual characteristics 1240 from an external source, it does not receive visual content 1230 for purposes of determining that intermediate result, although it may still need to receive visual content 1230 in order to produce modified content 1270. In one implementation, the data processing system 1200 obtains at least a portion of the modified content 1270 from an external source, and it displays it on the display 1274 and/or stores it in a storage memory.

In one implementation, external vendor 1298 provides at least a subset of the macular impairment condition input data 1210, selected macular impairment dataset 1220, visual content 1230 and/or selected visual characteristics 1240 to the data processing system 1200, and the data processing system 1200 then produces modified content 1270. For example, at least part of the selected macular impairment dataset 1220 and/or selected visual characteristics 1240 may be developed by the external vendor 1298 and may be provided to the data processing system 1200 and/or to user 1280. This could be advantageous, for example, if the data processing system 1200 will be processing some visual content that has already been analyzed at least in part by the external vendor 1298, in which case the external vendor 1298 would be able to provide at least partial intermediate results, and possibly even part or all of the modified content 1270.

In one implementation, database 1250 is completely included within the data processing system 1200. In one implementation, database 1250 is completely external to the data processing system 1200, possibly stored on a storage memory attached to the data processing system 1200 via a local connection (e.g., a USB or WiFi interface), or possibly stored on a storage memory coupled to the data processing system 1200 via a network (e.g., a remote cloud-based memory volume). In one implementation, part of the database 1250 is included within the data processing system 1200, and part of the database 1250 is external to the data processing system 1200.

An advantage of determining at least some of the intermediate results selected macular impairment dataset 1220 and selected visual characteristics 1240 independent of the data processing system 1200 is that the architecture and operation of the data processing system 1200 may be simplified by reducing the need for determining such intermediate results when computing the modified content 1270.

Another advantage of determining such intermediate results and/or modified content 1270 independently and making them available to the data processing system is that at least some of the intermediate results and/or modified content 1270 may be determined by an external vendor and provided to the data processing system 1200 and/or to the user 1280 on demand. Having an external vendor develop such intermediate results and/or modified content 1270 independent of the operation of data processing system 1200 may ensure a higher accuracy in the modified content 1270 because the external vendor may have access to expanded computational power and/or may be able to develop more sophisticated models for the computation of such intermediate results and/or modified content 1270.

In general, external vendor 1298 may determine some or all of the intermediate results and/or modified content 1270, and may make such determined intermediate results and/or modified content 1270 available to the data processing system 1200. In one implementation, external vendor 1298 provides to data processing system 1200 and/or to user 1280 at least some of the intermediate results and/or modified content 1270, either by storing them in database 1250 or by transmitting them directly to the data processing system 1200.

In one implementation, external vendor 1298 manages database 1250 by hosting the database 1250 on a storage memory controlled by external vendor 1298. In one implementation, external vendor 1298 permits data processing system 1200 and/or users 1280 to access these intermediate results on demand from a storage memory controlled by the external vendor 1298, using a login and password or another security or authorization framework (e.g., using an SSL secure protocol). In one implementation, the external vendor 1298 is hosting these intermediate results on a website or on an electronic commerce portal accessible through a communication network. In one implementation, external vendor 1298 provides at least some of the intermediate results and/or modified content 1270 on a portable storage medium, such as a DVD or another optical medium, or on a portable storage drive (e.g., a USB flash memory drive).

In the embodiment of FIG. 12, the macular impairment condition input data 1210, visual content 1230, the intermediate results selected macular impairment dataset 1220 and selected visual characteristics 1240, and/or the modified visual content 1270 may be in any data format as long as the format is recognized and can be processed by the data processing system 1200 and/or by its constituent logic modules (if any). For example, some or all of the macular impairment condition input data 1210, visual content 1230, intermediate results selected macular impairment dataset 1220 and selected visual characteristics 1240, and/or modified visual content 1270 may be encrypted, compressed, or formatted in a data file that complies with a specific protocol (e.g., XML).

As long as the intermediate results and other data received by the data processing system 1200 are in a format that is recognized and can be processed by the data processing system 1200 and/or by its constituent logic modules (if any), the intermediate results and such data are construed to be adapted to be used (or to be suitable to be used) by the data processing system 1200 as a basis for the computation of the modified visual content 1270 and/or for other operations performed by the data processing system 1200, regardless of whether any such intermediate results or data may be further processed or combined with other data. For example, a particular visual characteristic included in the selected visual characteristics 1240 may be formatted using a particular meta tag that is recognized by the data processing system 1200, but the data processing system may need to extract only part of the data included in that visual characteristic (e.g., extracting just a color or a shape from the data received and corresponding to that visual characteristic). In general, as long as an intermediate result or other data is made available and is usable as a basis for the computation of the modified visual content 1270 and/or other operations to be performed by the data processing system 1200, such intermediate result and data are construed to be adapted for such use, regardless of whether the intermediate result or data is further processed and/or is combined with other intermediate results or other data.

In the embodiment of FIG. 12, intermediate results that are received from an external source are adapted to be used by the data processing system 1200 as a basis for the computation of at least part of the modified visual content 1270, which corresponds to at least part of the visual content 1230.

This specification describes in detail various embodiments and implementations of the present invention, and is open to additional embodiments and implementations, further modifications, and alternative constructions. There is no intention to limit the invention to the particular embodiments and implementations disclosed; on the contrary, this patent is intended to cover all modifications, equivalents and alternative embodiments and implementations that fall within the scope of the claims.

As used in this specification, a set means any group of one, two or more items. Analogously, a subset means, with respect to a group of N items, any set of such items consisting of N−1 or less of the respective items.

As used in this specification, the terms “include,” “including,” “for example,” “exemplary,” “e.g.,” and variations thereof, are not intended to be terms of limitation, but rather are intended to be followed by the words “without limitation” or by words with a similar meaning Definitions in this specification, and all headers, titles and subtitles, are intended to be descriptive and illustrative with the goal of facilitating comprehension, but are not intended to be limiting with respect to the scope of the inventions as recited in the claims. Each such definition is intended to also capture additional equivalent items, technologies or terms that would be known or would become known to a person of average skill in this art as equivalent or otherwise interchangeable with the respective item, technology or term so defined. Unless otherwise required by the context, the verb “may” indicates a possibility that the respective action, step or implementation may be achieved, but is not intended to establish a requirement that such action, step or implementation must occur, or that the respective action, step or implementation must be achieved in the exact manner described.

What is claimed is:

1. A data processing system for assisting a visually-impaired user to view visual content, the data processing system comprising:
a. a logic module configured to identify a visual deficiency of the user, wherein the visual deficiency interferes with the user's ability to view the content;
b. a logic module configured to modify at least one visual characteristic of at least a portion of the content, wherein the modification is based on the visual deficiency of the user; and
c. a logic module configured to display on an electronic display at least a subset of the modified content.

2. The data processing system of claim 1, wherein:
a. a symptom of the visual deficiency is tunnel vision, and the modification of at least one visual characteristic of at least a portion of the content includes compression or warping of displayed data;
b. the visual deficiency is macular degeneration, and the modification of at least one visual characteristic of at least a portion of the content includes remapping displayed data around limited vision spots in the visual field of the user;
c. a symptom of the visual deficiency is loss or decline in color perception, and the modification of at least one visual characteristic of at least a portion of the content includes alteration of one or more colors of displayed data; or
d. the visual deficiency is glaucoma, and the modification of at least one visual characteristic of at least a portion of the content includes remapping displayed data around decreased acuity spots in the visual field of the user.

3. The data processing system of claim 1, wherein the visual deficiency includes at least one peripheral retinal function impairment condition.

4. The data processing system of claim 3, wherein the at least one peripheral retinal function impairment condition includes at least one of the following:
a. Retinitis Pigmentosa
b. Glaucoma
c. Choroideremia
d. Congenital Retinal dystropies
e. Usher's Disease

5. The data processing system of claim 1, wherein the visual deficiency includes at least one macular impairment condition.

6. The data processing system of claim 5, wherein the at least one p macular impairment condition includes at least one of the following:
a. Macular Degeneration
b. Diabetic Macular Ischemia and edema
c. Uveitic Macular edema
d. Loss of Macular function from Retinal Artery and Venous Occlusions
e. Stragardt's Disease
f. Ocular Albinism
g. Cone Rod dystrophy
h. Best's Disease
i. Retinopathy of Prematurity
j. Congenital Retina Dystrophies
k. Macular Ischemia secondary to stroke
l. Histoplamosis
m. Myopic degeneration
n. Optic nerve hypoplasia
o. Cone-Rod Dystropy

7. A computer implemented method for assisting a visually-impaired user to view visual content, the method comprising:
a. identifying a visual deficiency of the user that interferes with the user's ability to view the content;
b. based on the visual deficiency of the user, modifying at least one visual characteristic of at least a portion of the content; and
c. displaying on an electronic display at least a subset of the modified content.

8. The method of claim 7, wherein:
a. a symptom of the visual deficiency is tunnel vision, and the modification of at least one visual characteristic of at least a portion of the content includes compression or warping of displayed data;
b. the visual deficiency is macular degeneration, and the modification of at least one visual characteristic of at least a portion of the content includes remapping displayed data around limited vision spots in the visual field of the user;
c. a symptom of the visual deficiency is loss or decline in color perception, and the modification of at least one visual characteristic of at least a portion of the content includes alteration of one or more colors of displayed data; or
d. the visual deficiency is glaucoma, and the modification of at least one visual characteristic of at least a portion of the content includes remapping displayed data around decreased acuity spots in the visual field of the user.

9. The method of claim 7, wherein the visual deficiency includes at least one peripheral retinal function impairment condition.

10. The method of claim 9, wherein the at least one peripheral retinal function impairment condition includes at least one of the following:
a. Retinitis Pigmentosa
b. Glaucoma
c. Choroideremia
d. Congenital Retinal dystropies
e. Usher's Disease

11. The method of claim 7, wherein the visual deficiency includes at least one macular impairment condition.

12. The method of claim 12, wherein the at least one macular impairment condition includes at least one of the following:
a. Macular Degeneration
b. Diabetic Macular Ischemia and edema
c. Uveitic Macular edema
d. Loss of Macular function from Retinal Artery and Venous Occlusions
e. Stragardt's Disease
f. Ocular Albinism
g. Cone Rod dystrophy
h. Best's Disease
i. Retinopathy of Prematurity
j. Congenital Retina Dystrophies
k. Macular Ischemia secondary to stroke
l. Histoplamosis
m. Myopic degeneration
n. Optic nerve hypoplasia
o. Cone-Rod Dystropy
